(19) United States
(12) Patent Application Publication
(10) Pub. No.: US 2023/0279527 A1
(43) Pub. Date: Sep. 7, 2023

(54) METHOD FOR PRODUCING STEEL STRIP

(71) Applicant: SMS GROUP GMBH, Düsseldorf (DE)

(72) Inventors: Ingo SCHUSTER, Willich (DE); Thomas HENKEL, Duisburg (DE); Volker WIEGMANN, Duisburg (DE); Markus REIFFERSCHEID, Korschenbroich (DE); Hans FERKEL, Düsseldorf (DE)

(73) Assignee: SMS GROUP GMBH, Düsseldorf (DE)

(21) Appl. No.: 18/017,510

(22) PCT Filed: Jun. 29, 2021
(86) PCT No.: PCT/EP2021/067764

§ 371 Date: Jan. 23, 2023

(30) Foreign Application Priority Data
Jul. 23, 2020 (DE) 10 2020 209 299.0

(51) Int. Cl. C22C 33/04; B21B 1/26; B21B 3/02; B22D 11/00; C22C 38/50; C22C 38/48; C22C 38/46; C22C 38/54; C22C 38/42; C22C 38/04; C22C 38/02; C22C 38/00

(52) U.S. Cl. CPC C22C 33/04; B21B 1/26; B21B 3/02; B22D 11/001; C22C 38/50; C22C 38/48; C22C 38/46; C22C 38/54; C22C 38/42; C22C 38/04; C22C 38/02; C22C 38/001

(57) ABSTRACT

A method for producing steel strip, in particular hot strip in the form of coiled coils or in the form of folded individual sheets, in which a steel melt is first produced, this is then formed into a strand in a continuous casting system, the strand is then fed into a heating unit and the heated strand is then rolled into hot strip in a subsequent rolling mill. The casting of the strand, the passage through the heating unit, and the rolling take place in a continuous process. To be able to produce hot-rolled steel strips in the most energy-efficient way possible and to make these strips available for further processing into high-quality cold-rolled and, if necessary, coated strips, the invention provides that, first of all, a steel melt is produced.

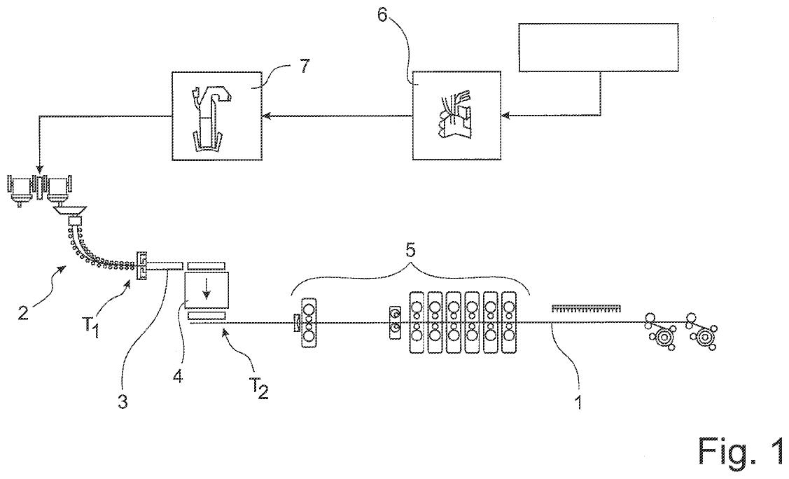

### FIELD

The invention relates to a method for producing steel strip, in particular hot strip, in the form of wound coils or in the form of folded individual sheets, in which a steel melt is first produced, then this steel melt is formed into a strand in a continuous casting system, then the strand is fed into a heating unit either undivided or subdivided into individual slabs, and then the heated strand or the heated slabs are rolled into a strip in a downstream rolling mill. The strip, in particular the hot strip, should preferably be produced without intermediate cooling of the strand or slabs to ambient temperature (20° C.). The purpose is to provide a steel strip which is intended for further processing into finished products with visually appealing surfaces, such as visible automotive components, packaging metal sheet, household appliances, or non-grain-oriented electrical sheets.

### BACKGROUND

Hot-rolled strips as primary material, for example made from ULC/IF steels for the production of automotive outer skin material or comparably visually appealing surfaces, are manufactured via the process route involving blast furnace (pig iron), blowing steel mill (BOF), optional vacuum treatment, further secondary metallurgical steps, and continuous casting into slabs, followed by rolling into hot-rolled strips in a hot strip mill. To achieve the desired combination of strength and other advantageous processing properties, the chemical compositions of the melts to be produced are strongly focused on maintaining maximum contents of admixtures of steel constituents such as Cu, Cr, Ni, Mo as well as undesirable contents of S, N, and H.

The conventional route allows the required chemical compositions to be produced by desulfurizing the pig iron prior to charging into the converter, by limiting the nitrogen content via process-related high decarburization rates during oxygen blowing in the converter, by lowering the carbon content, if necessary by means of vacuum treatment, to 20 ppm (i.e., 0.002 wt. %) and lower, by fine-tuning the analysis in a secondary metallurgical treatment step, and by casting the steel into slabs with thicknesses above 200 mm.

In this route, it is usually intended to allow the cast slabs to cool in a slab store and then to subject them to a surface inspection. This inspection can be carried out completely or only partially on representative slabs of a melt. The inspected (and where necessary repaired) slabs are subsequently combined into rolling programs and inserted into a downstream heating unit in the pre-planned sequence.

This approach means that the production processes for the slabs (steel mill and casting operation) and hot rolling mill are separated from each other both in terms of time and location and can therefore also be planned.

Various previously known solutions are described in EP 1 752 549 A1, WO 2004/108971 A2, US 2016/108494 A1, DE 692 27 014 T2, DE 697 13 639 T2, EP 2 998 046 B1, CN 106148639 A, JP 2003064412 A, KR 1063666 B1, KR 2019076164 A, KR 1017511 B1, and KR 1412566 B1.

The disadvantage is that these so-called integrated steel mills (including blast furnace, possibly coking system and sintering system, and converter) require a relatively large amount of space, cause relatively high CO₂ emissions, and are high in investment costs.

Another disadvantage of conventional integrated steel mills is that the individual production steps in the steel mill and in hot forming are for the most part separated in time and location. This means that the cast slabs usually cool down to room temperature before their further processing.

Under these conditions, energy-saving direct input, soon after casting, is not possible or is only possible by incorporating special measures, such as transporting the slabs under thermal insulation hoods.

The disadvantage of the previously known solution for producing the steel grades to which the present invention applies thus is lack of energy efficiency paired with a comparatively high CO₂ impact on the environment.

Predominantly electrically operated melting units, such as electric arc furnaces (EAF), induction melting furnaces (IF) or others, on the other hand, require less space and are in principle already capable of producing high-quality steels today, provided the input materials are selected appropriately. However, these technologies have so far been predominantly used in the production of higher-alloy quality and tool steels as well as high-quality special steels with high internal purity. Steel melts subjected to deepest decarburization below 150 ppm of carbon and/or deepest denitrification below 50 ppm of nitrogen are not yet feasible in electric arc furnaces with charge weights above 100 t and melting times less than 50 minutes. This results in an average mass flow of 2 t/min for further processing. This mass flow is not sufficient for the simultaneous realization of sequence casting at high slab discharge temperatures to ensure direct feeding. For this, a mass flow above 4 t/min is common.

Since characteristic surface defects on reheated continuous cast slabs occur in particular when the cast slabs are used in the reheating unit upstream of the hot rolling mill at surface temperatures in the so-called low-toughness range, which is between 700° C. and 950° C. depending on the steel composition, these materials must be cooled to temperatures below this range.

The temperature range mentioned must be defined differently for each steel composition and can be read from the time-temperature transformation diagram (ZTU) of the material and/or calculated using metallurgical simulation methods (microstructure models). ThermoCalc/DICTRA, MatCalc, and others are current commercially available simulation tools.

The observed lower toughness in the said temperature range and the related tendency of the steels to form cracks along the austenite grain boundaries upon reheating is related to the density change during the austenite-ferrite-austenite microstructural transformation. When the cooling steel reaches its transformation temperature A₃, which is valid for it and depends on the chemical composition, the microstructural transformation begins via nucleation at the former austenite grain boundaries. Due to the lower density of the steel, the ferrite components expand, but are put under tension by the firmer austenite fraction, whereupon creeping begins. If this microstructural transformation is interrupted and the steel is heated again, the previously transformed volume fraction of ferrite shrinks, causing tensile stresses to be applied. These tensile stresses in conjunction with precipitation of nitrides and/or carbides in the area of the transforming microstructures lead to a weakening of the grain boundaries and, in the worst case, to cracking. Depending on the steel grade, this grain boundary damage can be near the surface only or deeper. Surfaces damaged in this way do not heal in the further course of processing, are visible as microcracks on the slab surfaces, and lead to very fine surface damage on the hot strip and ultimately to devaluation. Hot strips damaged in this way can therefore no longer be used for visually appealing surfaces.

The remedy to minimize the surface damage caused by reheating is either by specifying a temperature range which should not be used for direct input (also hot input) in the reheating furnaces, or by specifying the proportion of converted ferrite that is still tolerable. Direct input of the slabs in this case means that the converted volume fraction of the near-surface microstructure is less than 10% by volume. A metallurgist assumes from experience that, if the starting temperature for the austenite-ferrite transformation A₃ falls below 10 K, this volume fraction of the microstructure will be present as ferrite. Today, metallurgical simulation tools allow a better prediction of the onset of transformation and should preferably be used to define the limit temperatures.

Hot input, on the other hand, is when the microstructure has been transformed to at least 75% by volume, minimizing damage along former austenite grain boundaries. It is generally assumed that such a microstructure state is reached at temperatures A₁+20 K. Again, preference should be given to the use of metallurgical simulation methods in determining this temperature.

Direct input methods are available with the various thin slab technologies, but there is the problem here of a much larger ratio between the cast surface area and the volume, which increases the likelihood of the occurrence of steel mill and/or casting-related surface defects.

The underlying problem of the invention is to further develop a method of the type described above in such a way that it is possible to produce hot-rolled steel strips, in particular in the most energy-efficient way possible. In particular, it should be possible to process the material into high-quality cold-rolled and, if necessary, coated strips, such as is required for automotive outer skin panels and similarly visually appealing surfaces.

### SUMMARY

The solution to this problem offered by the invention is characterized in that, first, a steel melt is produced which has the following chemical composition:
maximum 0.02 wt. % carbon, preferably less than 0.01 wt. % carbon,
0.01 to 3.5 wt. % silicon, preferably less than 0.1 wt. % silicon,
maximum 2.5 wt. % manganese, preferably less than 1.0 wt. % manganese,
0.01 to 0.20 wt. % copper, preferably less than 0.15 wt. % copper,
maximum 0.40 wt. % chromium and nickel, preferably less than 0.20 wt % chromium and nickel,
niobium, titanium, vanadium, and boron, each at less than 0.10 wt. %, preferably titanium, vanadium, and boron at less than 0.05 wt. %,
maximum 70 ppm nitrogen, preferably less than 50 ppm nitrogen,
optionally other elements without iron in a proportion of less than 1.0 wt. %, which are specifically added or which enter the melt as an unavoidable admixture via the input materials, and
residual iron content,
wherein the preparation of the steel melt comprises the steps of:
a) melting solid, ferrous starting material in a preferably electrically operated smelting unit (for example in the form of an electric arc furnace, an induction furnace, or an SAF);
b) continuously feeding solid starting materials containing iron and carbon as well as air, oxygen and/or natural gas into the smelting unit to achieve a continuously strong boiling reaction in the flat bath phase over a period of between 2 and 30 min, preferably between 10 and 20 min (for the purpose of preventing the absorption of N from the furnace atmosphere);
(c) feeding the melt into a vacuum system and decarburizing the melt in the vacuum system at a maximum decarburization rate of 180 ppm/min carbon;
wherein this is followed by the steps:
d) feeding the melt thus pretreated into the continuous casting system;
e) casting the melt in the continuously operating continuous casting system;
f) feeding the strand or the slabs made therefrom into the heating unit and setting the required rolling temperature, wherein the strand or the slab enters the heating unit directly at a temperature greater than A₃-20 K, such that the volume fraction of ferrite in the near-surface regions of the strand or the slab is less than 5 vol % down to a depth of at least 5 mm, preferably down to a depth of 10 mm;
g) feeding the strand or slabs into the rolling mill and rolling the strand or slabs into a strip.

Step a) is preferably carried out in such a way that the proportion of solid starting materials corresponds to 10 to 70% of the total charge weight.

However, step a) can also be carried out in such a way that the solid starting materials are at least partially replaced by liquid input materials.

Step b) is preferably carried out in such a way that an input of at least 20 kg of carbon per minute, preferably between 30 kg and 150 kg of carbon per minute, into the melt results. The material continuously fed according to step b) preferably has an average carbon content of at least 0.5 wt. %, particularly preferably between 1.0 and 3.5 wt. %.

Step b) is further preferably carried out such that the melt has a nitrogen content of 5 to 60 ppm, preferably less than 30 ppm, prior to tapping from the smelting unit (6).

Step c) is preferably carried out to achieve an average decarburization rate between 30 ppm/min and 60 ppm/min, preferably between 40 ppm/min and 50 ppm/min.

The melt preferably has a carbon content of 0.0005 to 0.01 wt. %, preferably below 0.0040 wt. %, prior to performing step d).

The strand preferably has a surface temperature (T₁) of at least A₃-20 K, preferably above 800° C., downstream of the last segment of the continuous casting system when step e) is carried out.

The slabs can also be discharged from the production line for finishing before step f) is carried out, in particular to carry out inspection work, repair surface defects, and for dividing. The ejected slabs are then preferably fed to the heating unit after finishing and heated to the required rolling temperature. When the slabs are introduced into the heating unit when carrying out step f), the volume fraction of ferrite in the near-surface regions of the slab to a depth of at least 5 mm, preferably to a depth of 10 mm, is preferably at least 75 vol %.

Preferably, casting of the strand, passage through the heating unit and rolling take place in a continuous process. This can be carried out as an absolutely continuous process or also as a semi-continuous process (in which casting is only continuous in sections). Thus, although a combined casting-rolling system (i.e., rolling the cast strand directly) is a preferred embodiment of the proposed method, it is not mandatory.

The microstructural proportions are preferably determined by means of a computational model using known metallurgical simulation methods for the thermodynamics and kinetics of microstructural changes and phase formation. The computer model, designed as an automation system, provides the necessary information for controlling and regulating the casting process as well as the necessary decision criteria that are used to control the slabs for direct input or to discharge them into the slab finishing line.

The management of the overall process is preferably controlled and/or regulated by a higher-level process management system.

In a first step a), a molten bath is created in the smelting unit by charging solid starting materials in combination with liquid starting materials (e.g. liquid pig iron and/or the liquid sump remaining in the melting unit). This can be done in that solid input materials such as scrap steel and virgin material such as direct reduced iron (DRI), hot briquetted iron (HBI), or solid pig iron (PI) are fed into the melting unit basket by basket or by means of other suitable devices such as shaking troughs, preheating shafts, etc. The proportion of these input materials is up to 70% of the tapped weight to be achieved.

According to step b) above, there will be an input of at least 65 kg of carbon per minute into the melt with simultaneous consumption of this amount of carbon, due to the further feeding of materials containing iron and carbon. The carbon input mentioned above, in combination with the artificially offered oxygen as well as the dissolved oxygen in the molten bath, leads to a sufficiently strong boiling reaction,

[C]_{dissolved}+[O]_{dissolved}={CO}_{gaseous}

or

2[C]_{dissolved}+{O₂}_{gaseous}=2{CO}_{gaseous}

which in turn counteracts the physically induced tendency of nitrogen absorption during the melting process in the electric arc furnace.

Step b) above is preferably carried out in such a way that the melt has a nitrogen content on tapping from the smelting unit of preferably less than 30 ppm in the liquid steel.

The ferrous and carbonaceous materials to be added continuously preferably consist of sponge iron (DRI—direct reduced iron) and/or of HBI (hot briquetted iron) as well as of liquid and/or solid desulfurized pig iron. The selected mixture of the material mix preferably has an average carbon content of at least 0.5 wt. %, particularly preferably between 1.0 and 3.5 wt. %.

Step b) above is preferably controlled and/or regulated by a process control system of the smelting unit.

Step c) above is preferably carried out to achieve an average decarburization rate between 30 ppm/min and 60 ppm/min, preferably between 40 ppm/min and 50 ppm/min. This step is further preferably carried out until the melt has a carbon content of not more than 0.0020 wt. %.

From an energy point of view and taking into account the factors influencing surface quality, it has proved particularly advantageous if the strand downstream of the last segment of the continuous casting system (i.e., ultimately immediately downstream of the continuous casting system) has a temperature of at least 800° C., preferably above its austenite-ferrite transformation temperature A₃-20 K.

However, it is preferred that the strand or the slabs cut to length have an average temperature of between 1,050° C. and 1,280° C. at the outlet from the heating unit.

The proposed method enables the production of high quality end products, wherein the direct input method without intermediate cooling to room temperature is used; this has significant energy advantages.

Accordingly, the proposed concept enables energy-saving production of hot-rolled steel strips for further processing into high-quality, cold-rolled and, if necessary, coated strips, as required, for example, in the automotive industry, the household goods industry, and the packaging industry.

For this purpose, mainly solid input materials (scrap, DRI, HBI, pig iron) are melted in the electric arc furnace (electric melting furnace), which is followed by the above-mentioned secondary metallurgical treatment in a vacuum for decarburization (for the secondary metallurgical treatment in the vacuum system, any types can be considered, in particular circulation degassing or tank degassing) and, if necessary, a ladle stand treatment for desulfurization. Then continuous casting takes place in the continuous casting system. The slabs or a continuous strand produced are used in the above-mentioned heating unit and heated to the temperature required for hot rolling, or their temperature profile is equalized and then rolled out to form hot strip in the rolling mill.

Preferably, a total productivity (throughput) of at least 5 t/min, measured in terms of the casting output of the continuous casting system in continuous operation for at least 120 min, is provided.

The described method allows the production of a chemical composition of the strip with a content of Cu+Cr+Ni of less than 0.2 wt. %, as well as a content of S of less than 120 ppm and a content of N of less than 50 ppm, while at the same time providing the highest possible scrap input into the electric arc furnace, which is at least 25 wt. %.

This makes it possible to produce hot-rolled strips as a precursor material, for example from ULC/IF steels for the production of automotive outer skin material or comparably visually appealing surfaces via the electric steel route described in accordance with the invention, resulting in more favorable investment costs, reduced CO₂ emissions, the possibility of recycling, and a higher degree of flexibility.

Also advantageous are a fast production cycle when slabs are fed directly and a high surface quality.

Advantageous use is thus made of the fact that the advantage of utilizing the casting heat, familiar from the thin-slab casting-rolling method, is combined with a steelmaking process based on solid charge materials which, despite a high scrap content (of more than 15 wt. %), allows steel grades to be produced which, in terms of their surface quality, are also suitable, for example, for outer skin applications in the automotive industry.

At the same time, the method described permits energy-saving reheating of the cast strand or slabs to rolling temperature by directly inputting the slabs, preferably at temperatures above 800° C., from the casting machine into a heating unit.

Furthermore, this type of direct input of the slabs produced in this way allows prevention of at least 90% of the surface defects (such as microcracks in the edge area and on the slab surfaces) which would otherwise occur during cooling of the slabs to temperatures between 800° C. and 600° C. and the subsequent reheating to the required hot rolling temperature.

Thus, logistic and technological coupling of crude steel production on the basis of scrap and other solid input materials, the necessary vacuum treatment of the crude steel to set low carbon values and lowest nitrogen contents, and continuous casting with the requirement of a high casting capacity to ensure the input of the strand or the cut slabs above the temperature of the beginning of the austenite-ferrite transformation A₃-20 K applicable to the respective steel composition into a downstream heating unit is envisaged.

The solid input materials are assembled and charged for melting in the electric arc furnace such that to ensure a high decarburization rate having a minimum size that is limited downward. The production output of this crude steel stage advantageously exceeds the value specified by the final processing stage (continuous casting) by at least 10%.

The crude steel produced in this way is subsequently lowered to the required C content in a vacuum system. This is preferably done in such a way that the decarburization rate is adjusted such that the production output of this process stage is 5% above the value required by the last processing stage (continuous casting).

The continuously producing casting machine is preferably set such that the strand or slab outlet temperature from the last segment is about 20 K above the temperature range of low toughness required for the steel in question.

The use of DRI/HBI with specially adjusted C content (e.g., high content to reduce blowing coal or low content for better process control via coal injection) benefits the process. The boiling reaction in the electric arc furnace can already be specifically influenced by this in the context of step b) above.

It is also advantageous to use CO₂-free or CO₂-reduced DRI/HBI, for example by direct reduction with H₂. Hot charging of DRI is also possible.

Where continuous casting or the use of a continuous casting machine is mentioned in the context of the method described here, this is to mean all the possibilities commonly used to produce a metallic strand. In addition to the preferred continuous casting system in which the strand emerges from the mold and is deflected in an arc from the vertical to the horizontal, thin slab casting systems with casting thicknesses from 30 mm to 90 mm or strip casting systems or twin-roller casting systems with casting thicknesses between 1 mm and 30 mm can also be used.

### BRIEF DESCRIPTION OF THE FIGURES

The drawing shows an exemplary embodiment of the invention. The single FIGURE schematically shows the preparation of steel melt, a downstream continuous casting system with a downstream heating unit and rolling mill.

### DETAILED DESCRIPTION

The FIGURE schematically shows a production line that can be used to manufacture hot-rolled strip 1.

First, starting material is melted in an electric arc furnace 6. The melt is then fed to a vacuum system 7, where it undergoes secondary metallurgical treatment. The ready-to-cast melt then enters a continuous casting system 2, in which a strand 3 (slab) is cast in a known manner. Strand 3 has the temperature T₁ immediately downstream of the continuous casting system 2 (namely downstream of its last segment).

The slab then enters a heating unit 4, in which the slab is heated to a temperature T2 at which it then enters the rolling mill 5 and is rolled into the finished hot strip 1.

The method described can be used to produce highest-quality steels (for example for outer skin grades in the automotive industry) by means of electric arc furnaces by selecting the input materials, optimizing the process control, preventing non-metallic inclusions, and synchronizing with downstream process steps (in particular in the form of vacuum decarburization, i.e., secondary metallurgical treatment) by continuous casting into a strand 3 having a thickness of 90 to 310 mm.

The crude steel preferably has a maximum carbon content of 0.020 wt. % when tapped from the smelting unit and, as mentioned, is produced in the electric arc furnace 6. Preferably, solid metallic input materials are used, wherein the process control enables the production of a crude steel with low contents of undesirable accompanying elements (Cu, Cr, Ni) and the lowest contents of gases (nitrogen, hydrogen). The crude steel produced is decarburized in the vacuum system 7 and subsequently formed into strand 3 on the continuously producing casting machine 2.

In particular, scrap, pig iron, and sponge iron (DRI and/or HBI) are used as metallic input materials, which lead to a low sulfur input.

The metallic input materials also have a low content of undesirable accompanying elements.

New input material can be added with respect to the undesired steel companion and adapted to the brand of steel to be produced.

The metallic input materials are selected in such a way that a total carbon input of at least 1 wt. % is possible.

The metallic input materials are preferably fed in such a way that a strong boiling reaction is present throughout the flat bath phase, which is ensured by the addition of at least 65 kg carbon/min.

Preferably, melting and slagging are carried out in such a way that a nitrogen content below 30 ppm is achieved in the liquid steel before tapping.

Decarburization of the crude steel melt takes place in vacuum system 7 at a maximum decarburization rate of 120 ppm/min carbon down to carbon contents below 0.010 wt. % before delivery to the casting machine.

The decarburization of the crude steel melt in the vacuum system 7 is further preferably carried out in such a way that the system is operated at an average decarburization rate of 40 to 50 ppm/min carbon during the entire decarburization phase.

The secondary metallurgical treatment can also be provided for deoxidizing the decarburized steel melt in the vacuum system 7 and for adjusting the target composition and temperature homogeneity in the vacuum system or, if necessary, in a downstream atmospheric treatment plant.

The melt is poured on the continuously operating casting machine 2, at an outlet temperature from the last segment (temperature T₁) at the surface preferably of at least 800° C.

The production time of the continuous casting system 2 preferably comprises at least four melts cast continuously in succession.

Furthermore, the slab 3 produced in this way is fed directly into the downstream heating unit 4 to set an average discharge temperature (temperature T2) between 1,050° C. and 1,280° C.

An automatic surface inspection of the slab 3 can be performed between the outlet of the slab 3 from the last segment of the continuous casting system 2 and its entry into the downstream heating unit 4.

Slabs 3 with surface defects can be automatically discharged from the production line and repaired after cooling. Repaired slabs can be returned to the production process.

Thus, the basic concept of the proposed method is aimed at arranging the processes of steel melting in the electric arc furnace 6, vacuum treatment in the vacuum unit 7, and continuous casting of the slabs 3, preferably with a thickness greater than 110 mm, in such a way that the slabs 3 leaving the continuous casting system 2 have sufficiently high temperatures so that they can be inserted into the heating unit 4 (preferably a walking beam furnace) without risk of surface defects.

To ensure the main requirement of high slab temperatures at the entry to the heating unit 4, the entire process upstream is optimized for high throughput rates.

Accordingly, a high slab temperature results in a high casting speed and from this in turn a rapid provision of the melt from the vacuum system 7, which in turn leads to short treatment times in the electric arc furnace 6.

The short treatment times in the electric arc furnace 6 while limiting the nitrogen content in the steel require a high boiling reaction in the bath and a constant decarburization rate during the melting phase, as described above. Continuous pumping of DRI and/or other ferrous and carbonaceous input materials promotes this.

Rapid treatment in a vacuum paired with simultaneous reduction of the carbon content to minimum values is favored by the required minimum decarburization rate.

Thus, the proposed concept is based on a coupled process with several units arranged one after the other, whose processes are logistically linked in such a way that at the end the slabs 3 can be fed directly into the heating unit 4 without subsequently forming surface defects.

The method according to the invention from steel production to steel strip can be controlled and/or regulated by means of a higher-level process control system.

### LIST OF REFERENCE SYMBOLS

1 hot strip
2 continuous casting system
3 strand (slab)
4 heating unit (reheating unit)
rolling mill
6 smelting unit (electric arc furnace)
7 vacuum system
T₁ Temperature of the strand downstream of the last segment of the continuous casting system
T₂ Temperature of the strand at the outlet from the heating unit

1-18. (canceled)

19. A method for producing steel strip, in particular hot strip, in the form of wound coils or in the form of folded individual sheets, in which first a steel melt is produced, then this steel melt is formed into a strand in a continuous casting system, then the strand is fed, either undivided or divided into individual slabs, into a heating unit, and then the heated strand or the heated slabs are rolled into strip in a downstream rolling mill,
wherein, first, a steel melt is produced which has the following chemical composition:
maximum 0.02 wt. % carbon, preferably less than 0.01 wt. % carbon,
0.01 to 3.5 wt. % silicon, preferably less than 0.1 wt. % silicon,
maximum 2.5 wt. % manganese, preferably less than 1.0 wt. % manganese,
0.01 to 0.20 wt. % copper, preferably less than 0.15 wt. % copper,
maximum 0.40 wt. % chromium and nickel, preferably less than 0.20 wt. % chromium and nickel,
niobium, titanium, vanadium, and boron, each at less than 0.10 wt. %, preferably titanium, vanadium, and boron at less than 0.05 wt. %,
maximum 70 ppm nitrogen, preferably less than 50 ppm nitrogen,
optionally other elements without iron in a proportion of less than 1.0 wt. %, which are specifically added or which enter the melt as an unavoidable admixture via the input materials, and
residual iron content,
wherein the preparation of the steel melt comprises the steps of:
a) melting of solid, ferrous starting material in a smelting unit;
b) continuously feeding solid starting materials containing iron and carbon as well as air, oxygen and/or natural gas into the smelting unit to achieve a continuously strong boiling reaction in the flat bath phase over a period of between 2 and 30 min, preferably between 10 and 20 min;
c) feeding the melt into a vacuum system and decarburizing the melt in the vacuum system at a maximum decarburization rate of 180 ppm/min carbon;
wherein this is followed by the steps:
d) feeding the melt thus pretreated into the continuous casting system;
e) casting the melt in the continuously operating continuous casting system;
f) feeding the strand or the slabs produced therefrom into the heating unit and setting the required rolling temperature, wherein the strand or the slab enters the heating unit directly at a temperature greater than A₃-20 K, such that the volume fraction of ferrite in the near-surface regions of the strand or the slab is less than 5 vol % down to a depth of at least 5 mm, preferably down to a depth of 10 mm;
g) feeding the strand or slabs into the rolling mill and rolling out the strand or slabs into the strip.

20. The method according to claim 19, wherein step a) is carried out such that the proportion of solid starting materials corresponds to 10 to 70% of the total charge weight.

21. The method according to claim 19, wherein step a) is carried out in such a way that the solid starting materials are at least partially replaced by liquid input materials.

22. The method according to claim 19, wherein step b) is carried out in such a way that an addition of at least 20 kg of carbon per minute, preferably between 30 kg and 150 kg of carbon per minute, into the melt results.

23. The method according to claim 19, wherein the material continuously fed according to step b) has an average carbon content of at least 0.5 wt. %, preferably between 1.0 and 3.5 wt. %.

24. The method according to claim 19, wherein step b) is carried out such that the melt has a nitrogen content of 5 to 60 ppm, preferably less than 30 ppm, prior to tapping from the smelting unit.

25. Method according to claim 19, characterized in that step c) is carried out to achieve an average decarburization rate between 30 ppm/min and 60 ppm/min, preferably between 40 ppm/min and 50 ppm/min.

26. The method according to claim 19, wherein the melt has a carbon content of 0.0005 to 0.01 wt. %, preferably below 0.0040 wt. %, before carrying out step d).

27. The method according to claim 19, wherein the strand downstream of the last segment of the continuous casting system has a surface temperature (T₁) of at least A₃-20 K, preferably above 800° C., when step e) is carried out.

28. The method according to claim 19, wherein the slabs are discharged from the production line for finishing before carrying out step f), in particular for carrying out inspection work, repairing surface defects, and for dividing.

29. The method according to claim 28, wherein the discharged slabs are fed to the heating unit after finishing and heated to the required rolling temperature.

30. The method according to claim 19, wherein the casting of the strand, the passage through the heating unit, and the rolling take place in a continuous process.
